(19) United States
(12) Patent Application Publication
(10) Pub. No.: US 2011/0203875 A1
(43) Pub. Date: Aug. 25, 2011

(54) Method and Apparatus for Applying Variable Rates of Solid Stick Lubricant

(76) Inventor: Michael J. Mitrovich, Kenmore, WA (US)

(21) Appl. No.: 13/032,092

(22) Filed: Feb. 22, 2011

Related U.S. Application Data
(60) Provisional application No. 61/306,834, filed on Feb. 22, 2010.

(51) Int. Cl. B61K 3/02; F16N 29/02; F16N 15/00; F16N 9/04

(52) U.S. Cl. 184/37; 184/39

(57) ABSTRACT

A lubricant dispenser for dispensing at least one lubricant stick. The lubricant dispenser has a housing for holding the lubricant stick. The housing has a longitudinally slidable carriage member. The lubricant dispenser has a linear actuator for sliding the carriage member along a longitudinal axis resulting in the advancement of the lubricant stick out of said housing and against a surface to be lubricated.

### PRIORITY/CROSS-REFERENCE TO RELATED APPLICATIONS

This application claims the benefit of U.S. Provisional Application No. 61/306,834, filed Feb. 22, 2010, the disclosure of which is incorporated by reference.

### TECHNICAL FIELD

The disclosure generally relates to the field of lubrication dispensers. Particular embodiments relate to solid stick lubricant dispensers for lubricating railroad car wheels and/or rails.

### BACKGROUND

A typical railroad rail has a gauge face and a top-of-rail face. The gauge face is the surface of the track that engages the wheel flange of the wheel of a locomotive or railroad car. The top-of-rail face is the top running surface of the rail upon which the running surface of the wheels of a locomotive or railroad car travels. The wheel's running surface further has a “taping line,” a term used in the art to denote the center position of the wheel on the rail when the wheel-set is in its central position.

As with any metal on metal contact, a rail wheel travelling down a rail will generate friction, noise and wear to the contacting surfaces. Thus, controlling top-of-rail friction would provide significant benefits, namely reducing wear, reducing truck curving forces, improving running surface fatigue performance, and controlling noise.

Railroads have lubricated the gauge face surface of rails for over one hundred years, primarily as a means of controlling friction at the gauge face surface with the intent being to extend rail life. More recently, the railroad industry has developed a better understanding of the relationship between friction control and subsequent system behavior. This has allowed top-of-rail friction control to be included as a railroader's arsenal of tools for improving rail life and addressing other issues.

There are several common methods of applying top-of-rail lubricants. The most popular method of applying top-of-rail lubricants in North America is the use of a wayside applicator. A wayside applicator is an applicator mounted adjacent the rail (wayside, aka “trackside”). Wayside applicators are configured for automatically (e.g., as a train passes) applying grease to the gauge face or top-of-rail face of the rail (depending upon configuration). Typically, wayside applicators apply the grease by means of a spray. Less common are locomotive mounted top-of-rail lubricant systems that apply lubricant directly to the track or to one or more wheels behind the last driven axel of the locomotive, as a liquid or solid lubricant sprayed on or applied to the relevant surface.

### SUMMARY OF THE DISCLOSURE

Several exemplary lubrication dispensers are described herein.

An exemplary lubrication dispenser comprises a housing and a linear actuator. The housing is for mounting to the frame of an object having a surface to be lubricated. The housing holding at least one lubricant stick having an exterior surface therein. The housing has a longitudinally slidable carriage member. The linear actuator for reciprocating the carriage member along a longitudinal axis distally from a first position to a second position and advancing the lubricant stick out of the housing and against the surface to be lubricated, moving the carriage member proximally from the second position to the first position.

Another exemplary lubrication dispenser comprises a lubricant dispenser for dispensing lubricant sticks having an exterior surface. The lubricant dispenser comprises a housing and a linear actuator. The housing is for mounting to the frame of an object having the surface to be lubricated. The housing having a magazine holding a plurality of lubricant sticks. The housing having a longitudinally slidable carriage member, this carriage member having a pivot joint and a pawl pivotally connected to the carriage member at the pivot joint. The pawl can be rotated from a forward stick engaging position to a rearward free position. The pawl has a tooth for engaging the lubricant stick exterior surface when the pawl is in the forward stick engaging position. The linear actuator attaches to the carriage at the pawl. The linear actuator is for reciprocating the carriage member along a longitudinal axis from a first position to a second position. When reciprocating the carriage member from the first position to the second position, the carriage member sequentially advances the lubricant sticks out of the housing and against the surface to be lubricated. When moving the carriage member from the first position to the second position, the pawl rotates to the forward stick engaging position causing the tooth to engage the lubricant stick exterior surface, thereby advancing the lubricant stick out of the lubricant dispenser and into contact with the surface to be lubricated. When moving from the second position to the first position, the pawl rotates to the rearward free position causing the tooth to disengage the lubricant stick exterior surface.

Another exemplary lubrication dispenser comprises a lubricant dispenser for dispensing lubricant sticks having an exterior surface. The lubricant dispenser comprises a housing and a linear actuator. The housing is for mounting to the frame of an object having a surface to be lubricated. The housing having a magazine holding a plurality of lubricant sticks. The housing having a longitudinally slidable carriage member, the carriage member having a pivot joint and a pawl pivotally connected to the carriage member at the pivot joint. The pawl can be rotated from a forward stick engaging position to a rearward free position. The pawl has a tooth for engaging the lubricant stick exterior surface when the pawl is in the forward stick engaging position. The linear actuator attaches to the carriage at the pawl. The linear actuator is for reciprocating the carriage member along a longitudinal axis from a first position to a second position. When reciprocating the carriage member from the first position to the second position, the carriage member sequentially advances the lubricant sticks out of the housing and against the surface to be lubricated. When moving from the first position to the second position, the pawl rotates to the forward stick engaging position causing the tooth to engage the lubricant stick exterior surface, thereby advancing the lubricant stick out of the lubricant dispenser and into contact with the surface to be lubricated. When moving from the second position to the first position, the pawl rotates to the rearward free position causing the tooth to disengage the lubricant stick exterior surface. The linear actuator is a pneumatic cylinder attached to an air supply. The lubricant dispenser having a pressure regulator for adjusting the force asserted by the linear actuator through the carriage member to the lubricant stick when moving the carriage member from the first position to a second position. The housing having a magazine empty controller for determining when the magazine is empty and for stopping further reciprocation of the linear actuator.

Additional understanding of the devices and methods contemplated and/or claimed by the inventor can be gained by reviewing the detailed description of exemplary devices, presented below, and the referenced drawings.

### BRIEF DESCRIPTION OF THE DRAWINGS

FIG. 1 is a partial, environmental, side view of a first exemplary lubricant dispenser.

FIG. 2 is a partial, environmental, plan view of the exemplary lubricant dispenser of FIG. 1.

FIG. 3 is a partial, plan view of a second exemplary lubricant dispenser, illustrating the housing without a magazine, and a linear actuator.

FIG. 4 is a partial, lower perspective view of the exemplary lubricant dispenser of FIG. 3, illustrating a magazine shown with the pusher bar in its forward position.

FIG. 5 is a partial, lower perspective view of the exemplary lubricant dispenser of FIG. 3, illustrating a magazine shown with the pusher bar in its retracted position.

FIG. 6 is a perspective view of the exemplary lubricant dispenser of FIG. 3.

FIG. 7 is a partial, first perspective view of the exemplary lubricant dispenser of FIG. 3.

FIG. 8 is a partial, second perspective view of the exemplary lubricant dispenser of FIG. 3.

FIG. 9 is a partial, cross sectional view of the exemplary lubricant dispenser of FIG. 3.

FIG. 10 is a partial, cross sectional view of the exemplary lubricant dispenser of FIG. 3.

### DETAILED DESCRIPTION

The following description and the referenced drawings provide illustrative examples of that which the inventor regards as his invention. As such, the embodiments discussed herein are merely exemplary in nature and are not intended to limit the scope of the invention, or its protection, in any manner. Rather, the description and illustration of these embodiments serve to enable a person of ordinary skill in the relevant art to practice the invention.

The use of “e.g.,” “etc,” “for instance,” “in example,” and or and grammatically related terms indicates non-exclusive alternatives without limitation, unless otherwise noted. The use of “including” and grammatically related terms means “including, but not limited to,” unless otherwise noted. The use of the articles “a,” “an” and “the” are meant to be interpreted as referring to the singular as well as the plural, unless the context clearly dictates otherwise. Thus, for example, reference to “a linear actuator” includes two or more such “linear actuators,” and the like. The use of “exemplary” means “an example of” and is not intended to convey a meaning of an ideal or preferred embodiment.

As used herein, “lubricant stick” includes, but is not limited to, solid stick lubricants, solid lubricant sticks with hollow centers, solid sticks with hollow centers filled with a solid lubricant, gel lubricant, pelleted lubricant, etc.

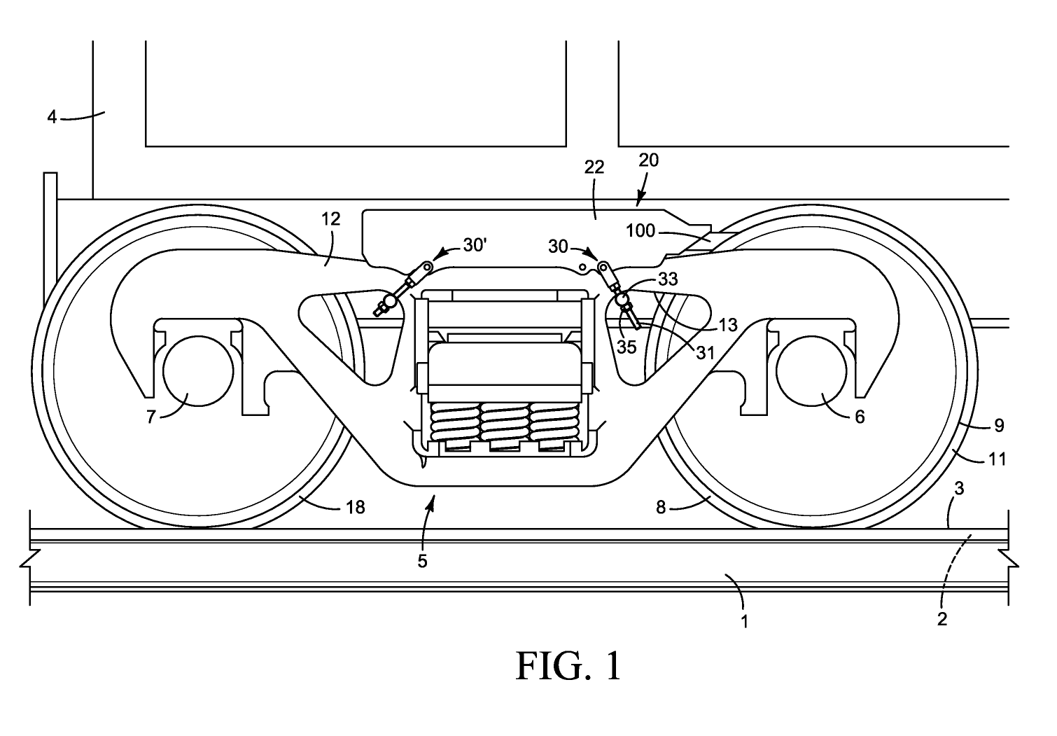

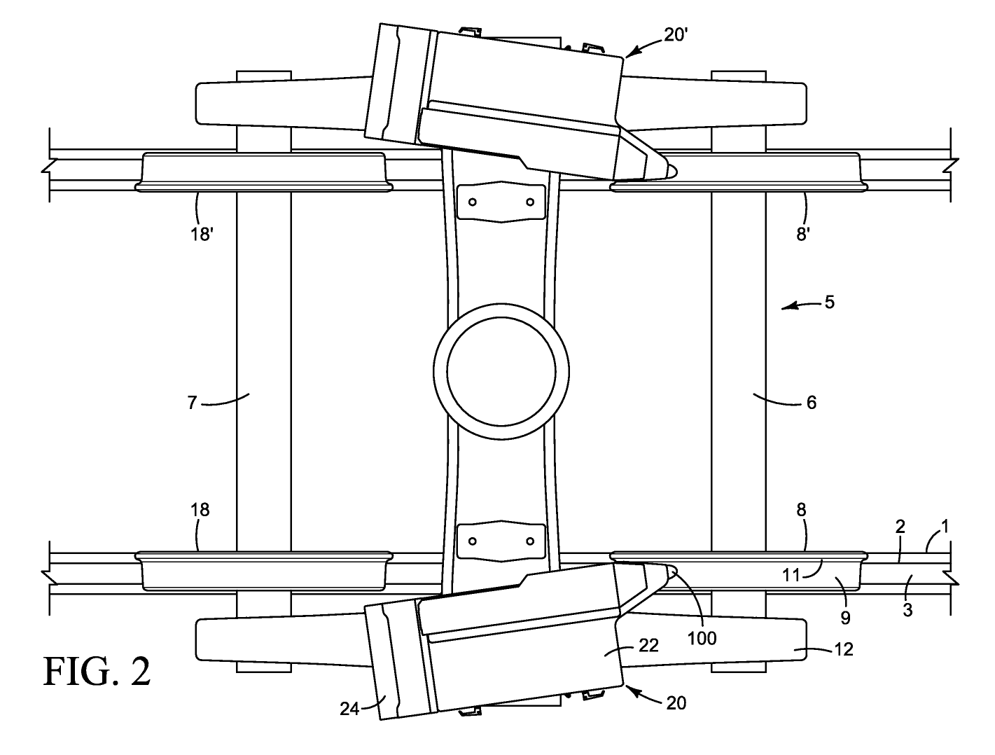

FIG. 1 is a partial, environmental, side view, and FIG. 2 is a partial, environmental, plan view, of the first exemplary lubricant dispenser 20, 20′. The lubricant dispenser 20 shown installed on a rail car 4 resting upon a rail 1. The rail 1 has a gauge face 2 and a top-of-rail face 3. The rail car 4 has a truck 5 having a frame 12, a first axle 6 and a second axle 7. The first axle 6 having a pair of first wheels 8, 8′. The second axle 7 having a pair of second wheels 18, 18′. The first wheel 8 has a running surface 9 and a wheel flange 11.

FIG. 1 illustrating the lubricant dispenser 20, having a housing 22 that is mounted on the truck frame 12 through use of a pair of mounting means 30, 30′ so that a lubricant stick 100 advanced from said housing 22 can be applied to the running surface 9 of the first wheel 8.

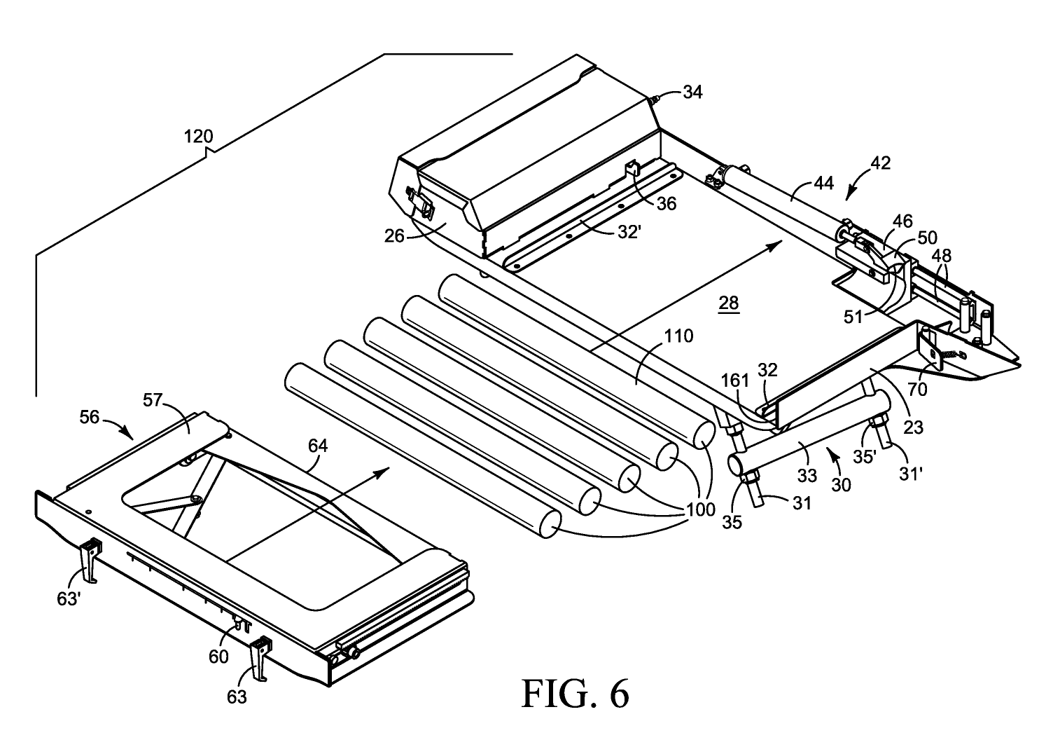

The mounting means 30, 30′, which can also be seen in FIG. 6, comprising a pair of downwardly extending legs 31, 31′ and a cross piece 33. The cross piece 33 passes through a hole 13 defined in the frame 12. A fastener, such as nut 35, 35′ can be threaded onto the downwardly extending legs 31, 31′ thereby holding the cross piece 33 in place. Tightening the fastener(s) securely attaches the lubricant dispenser 20 to the truck frame 12. While these Figures illustrate one exemplary manner for mounting the lubricant dispenser to the truck frame, this manner is not intended to be viewed as the only manner of doing so. For instance, the housing 22 could be fastened, strapped, bolted, welded, or otherwise attached to the truck frame 12; or the housing 22 could be fastened, strapped, bolted, welded, or otherwise attached to another part of the rail car 4, or of a locomotive or other object.

FIG. 2 illustrating the lubricant dispenser 20 having a housing 22 that includes a control panel 24. Preferably, the control panel 24 comprises a pressure gauge displaying system pressure, a reset switch for resetting the magazine empty controller, and an adjustable force regulator allowing an operator to vary and change the force exerted by the linear actuator.

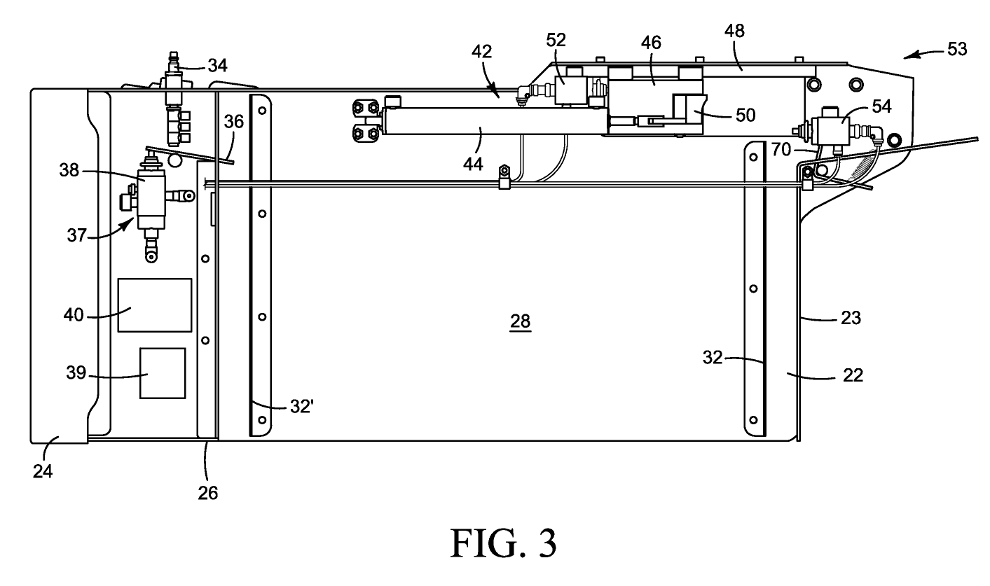

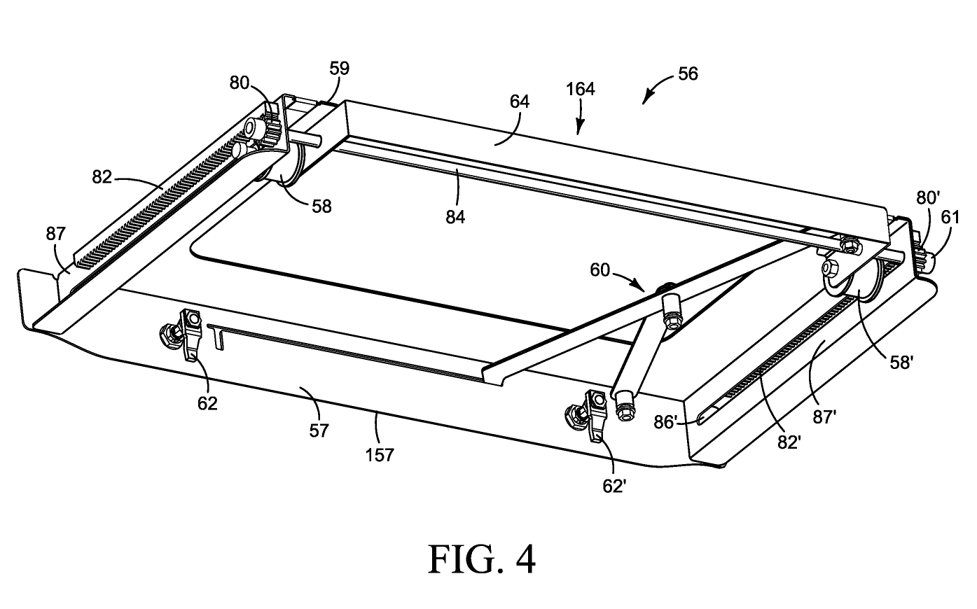

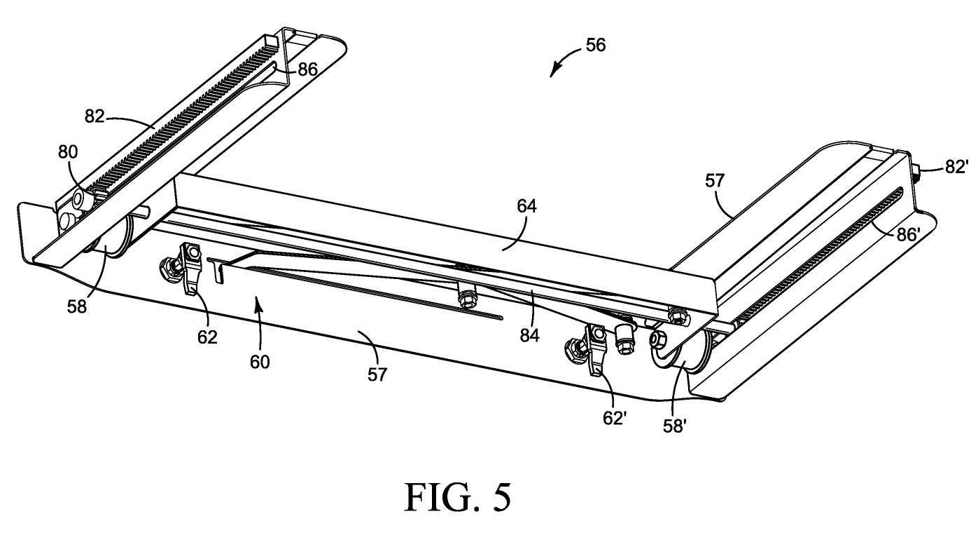

FIG. 3 is a partial, plan view of a second exemplary housing 22 having a linear actuator 42. FIG. 3 illustrating the housing 22 without a magazine present. FIG. 4 illustrates a partial, lower perspective view of the second exemplary lubricant dispenser, illustrating a magazine 56 shown with the pusher bar 64 in its forward position. FIG. 5 illustrates a partial, lower perspective view of the exemplary lubricant dispenser of FIG. 4, illustrating a magazine 56 shown with the pusher bar 64 in its retracted position. The housing 22 is not shown in FIG. 4 or FIG. 5. FIG. 6 illustrates the second exemplary lubricant dispenser 120 that results from the combination of the housing 22, linear actuator 42 (FIG. 3) and magazine 56 (FIGS. 4 and 5).

The second exemplary lubricant dispenser 120 is similar to the first exemplary lubricant dispenser 20 illustrated in FIGS. 1 and 2, described above, except as detailed below. Thus, the second exemplary lubricant dispenser 120 includes a housing 22 for mounting to the frame of an object having a surface to be lubricated. The housing 22 is configured for holding at least one lubricant stick 100. The lubricant dispenser 120 has a longitudinally slidable carriage member 46.

A linear actuator 42 is provided. Suitable linear actuators include, but are not limited to mechanical actuators (e.g., screw type, wheel and axle type, cam type), hydraulic actuators, pneumatic actuators, electro-mechanical actuators, linear motors, telescoping linear actuators and piezoelectric linear actuators. In exemplary lubricant dispenser of FIG. 3, the linear actuator 42 is a pneumatic cylinder 44 connected to an air supply via a pneumatic pressure line connector 34.

The linear actuator 42 having a first end mounted to the housing 22 and a second end connecting with the carriage member 46. The linear actuator 42 is for reciprocating the carriage member 46 along a longitudinal axis distally from a first position proximal to the linear actuator 42 to a second position distal from the linear actuator. FIG. 3 illustrating the carriage member 46 in its first position. Movement of the carriage member 46 from the first position to the second position advances a lubricant stick (not shown) out of the housing 22 and into the surface to be lubricated (not shown).

The carriage member 46 is slidably mounted on at least one rail 48, thereby enabling the carriage member 46 to be longitudinally moved from said first position to said second position, and back again.

The carriage member 46 comprises pivot joint (not shown) and a pawl 50 pivotally connected to said carriage member 46 at said pivot joint. The pawl 50 can be rotated from a forward stick engaging position to a rearward free position.

Mounted adjacent the carriage member 46 is a rear limit switch 52 and a forward limit switch 54. Depression of the rear limit switch 52 causing the linear actuator 42 to extend and move the carriage member 46 from the first position to the second position. Depression of the forward limit switch 54 causing the linear actuator 42 to retract and move the carriage member 46 to move the carriage member 46 from the second position to the first position. In the exemplary lubricant dispenser 120 shown in FIG. 3, the carriage member 46 is able to contact the rear limit switch 52 (shown in FIG. 3) and carriage front surface 65 or the pawl front surface 67 is able to contact the forward limit switch 54.

The exemplary lubricant dispenser 120 having a pressure adjustment means 39. The pressure adjustment means 39 can be controlled any number of ways, including but not limited to through the control panel 24, and via the control means 40 (discussed below). The pressure adjustment means 39 for adjusting the force asserted by the linear actuator 42 through the carriage member 46 to the lubricant stick 100 when moving the carriage member 46 from the first position to a second position. The more force exerted, the more lubricant is applied to the surface to be lubricated.

For instance, where the linear actuator 42 is a pneumatic actuator 44, the pressure adjustment means 39 could comprise an adjustable pneumatic pressure regulator.

The control means 40, if present, for controlling one or more actions of the lubricant dispenser 120. In one exemplary lubricant dispenser, the control means comprises a digital controller powered by a power source and a sensor means. The sensor means could include accelerometers, inclinometers, global position satellite (GPS) receivers, optical sensors, other manners of sensing the angle of track ahead.

The lubricant dispenser 120 having a magazine empty controller 37 for determining when the magazine 56 (shown in FIGS. 4, 5 and 6) is empty (no more lubricant sticks 100 are present). The magazine empty controller 37 stopping further reciprocation of the linear actuator 42, thereby keeping the lubricant dispenser from continuing to cycle, attempting to load another lubricant stick, when empty. In the illustrated exemplary lubricant dispenser of FIG. 3, the magazine empty controller 37 comprising a magazine empty lever 36 able to be brought into contact with an air pressure cut off switch 38. The exemplary lubricant dispenser of FIGS. 4 and 5 illustrates the pinion gear 80′ having a flange 61 extending there-from. The flange 61 configured for moving the magazine empty lever 36 away from the outside 26 of the housing 22, thereby depressing the air pressure cut off switch 38 and shutting off air pressure to the pneumatic cylinder 44. The control panel 24 enabling an operator to reset the air pressure cut off switch 38 after the lubricant dispenser 120 has been refilled with lubricant sticks.

The housing 22 having a front side 23 that generally faces the surface to be lubricated and an outside 26 that faces outwards. The inside of the housing 22 having a bottom surface 28 for supporting at least one lubricant stick and a pair of stick guides 32, 32′ extending there-from for aligning the lubricant stick(s). These stick guides 32, 32′ perpendicular to the throw of the linear actuator 42 and the longitudinal motion of the carriage 46.

The magazine 56 for advancing a plurality of lubricant sticks, sequentially, towards the linear actuator. This can be done via any number of means, including mechanical, electrical motors, gravity, and the spring biased mechanism shown in FIGS. 4 and 5.

The magazine 56 having a magazine frame 57 having a front 157, a back, and a pair of opposing sidewalls 87, 87′. The sidewalls 87, 87′ each defining an elongated channel 86, 86′ there-through. Mounted adjacent these elongated channels 86, 86′ are a pair of rack gears 82, 82′. These rack gears 82, 82′ for intermeshing with a pair of pinion gears 80, 80′ connected together via a spindle 84. The pusher bar assembly 164 is mounted to said spindle 84. The pusher bar assembly 164 having a pusher bar 64. By utilizing a rack and pinion gear configuration, the face of the pusher bar 64 is able to remain generally perpendicular to the sidewalls 87, 87′ as it moves from its retracted position (FIG. 5) to its forward position (FIG. 4).

The front 157 defining marking indicia that works with an indicator 60 connected to the pusher bar assembly 164. The indicia allows an operator to determine how many lubricant sticks are currently loaded in the magazine.

A pair of constant force springs 58, 58′ are utilized to spring bias the pusher bar assembly 164 and pusher bar 64 in its forward position (illustrated in FIG. 4). The springs 58, 58′ attaching on a first end to the inner side 59 of the frame 57, and on a second end to the pusher bar assembly 164. Other types of springs would also work.

FIG. 6 illustrating the exemplary lubricant dispenser 120 exploded, with the upper portion of the housing 22 removed (for purposes of illustration). The outside 26 of the housing defining a magazine opening 161 sized for receiving the magazine 56 therein.

To load the lubricant dispenser 120, a number of lubricant sticks 100 would be inserted into the housing 22 through the magazine opening 161. For instance, the housing could hold eight, two-inch diameter, thirty-inch long, solid lubricant sticks. The lubricant sticks 100 resting upon the housing bottom 28, aligned between the stick guides 32, 32′. The magazine 56 would then be slid into the housing 22 through the magazine opening 161. The outermost lubricant stick 100 presses against the pusher bar 64. As the magazine 56 is inserted further into the housing 22, the pusher bar 64, pushing against the lubricant sticks 100 held inside the housing 22, would be moved from its extended position to its retracted position. Upon fully pushing the magazine 56 into the housing 22, a locking means, such as the latches 62, 62′, having handles 63, 63′ could be used to lock the magazine 56 in the housing 22. In such a configuration, the pusher bar 64 (and lubricants sticks 100) is spring biased towards the inside of the housing 22.

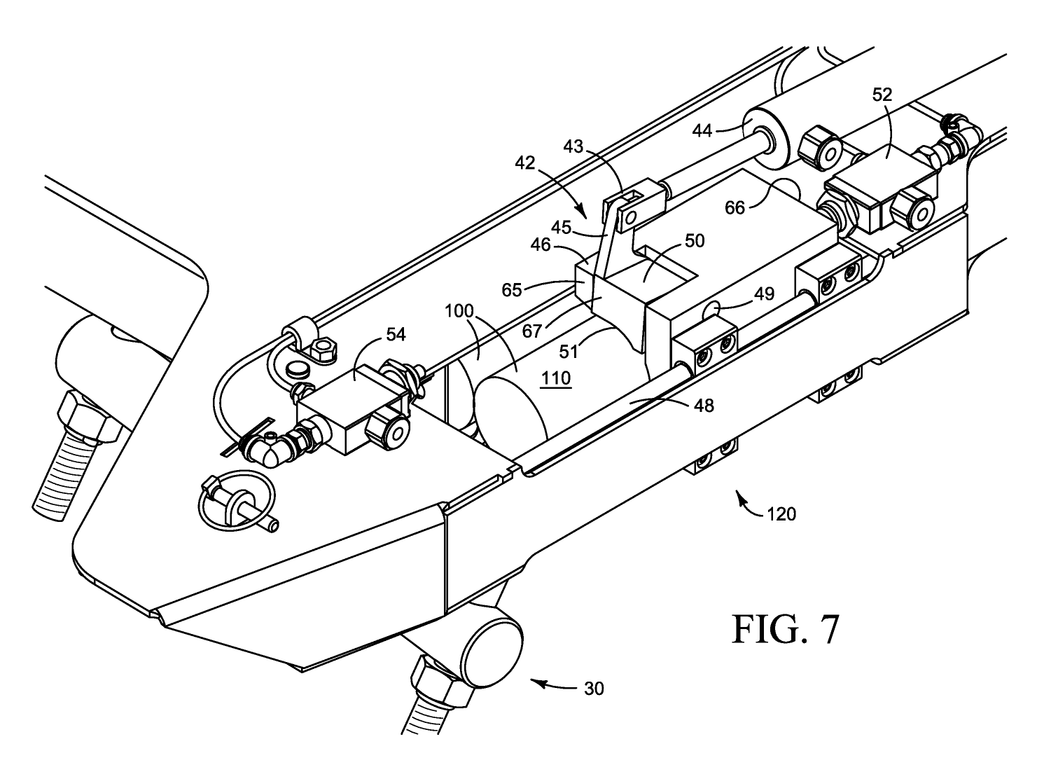

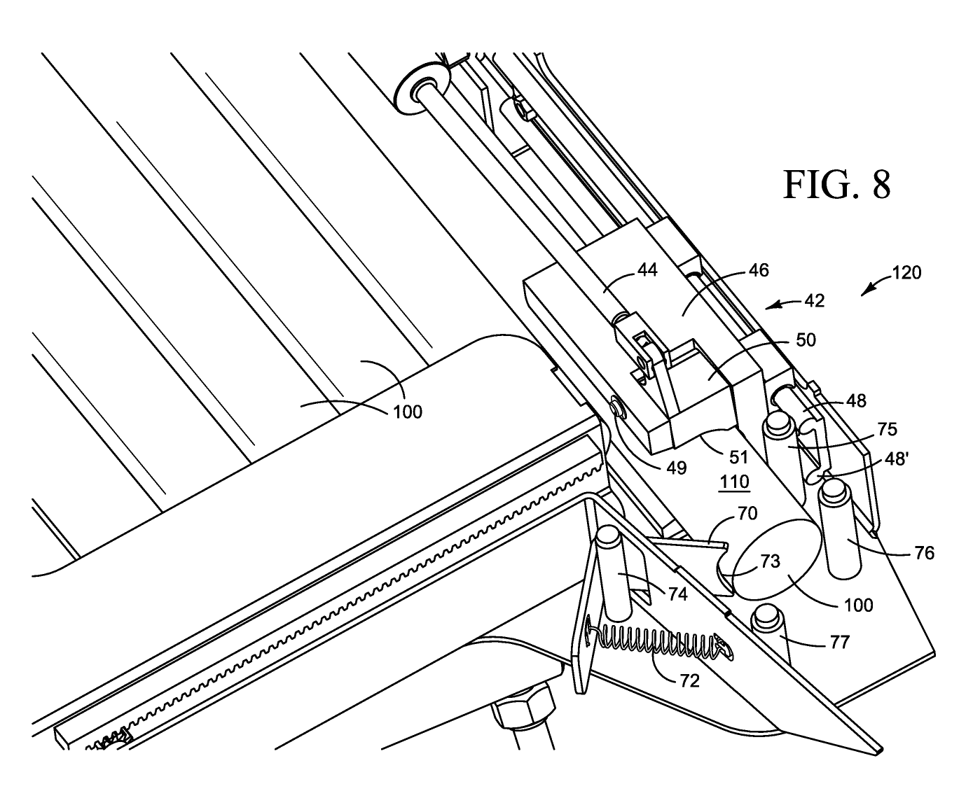

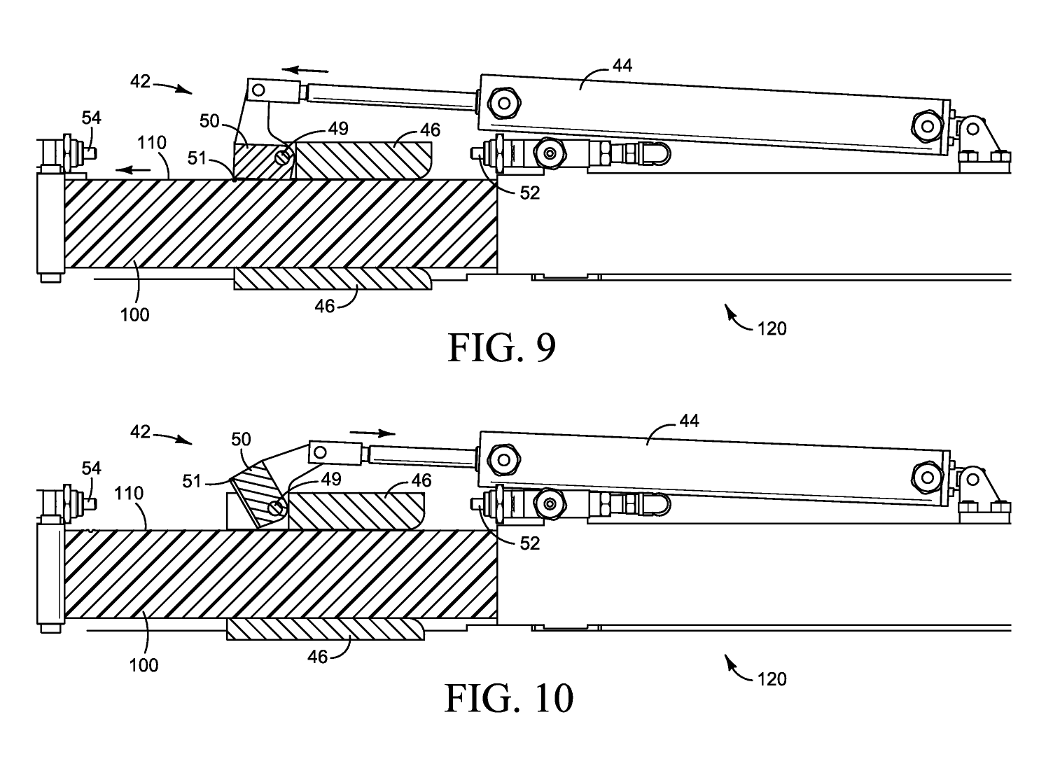

FIG. 7 is a partial, first perspective view of the second exemplary lubricant dispenser 120; FIG. 8 is a partial, second perspective view of the second exemplary lubricant dispenser of FIG. 7; FIG. 9 is a first partial, cross sectional representation of the second exemplary lubricant dispenser 120; and FIG. 10 is a second partial, cross sectional representation of the second exemplary lubricant dispenser 120.

The second exemplary lubricant dispenser 120 for dispensing lubricant sticks 100 having an exterior surface 110. The linear actuator 42 having a first end (not shown) mounted to the housing 22 and a second end 43 connecting with the carriage member 46 at a pawl tang 45. The linear actuator 42 is for reciprocating the carriage member 46 along a longitudinal axis distally from a first position proximal to the linear actuator 42 (illustrated in FIG. 7) to a second position distal from the linear actuator 42 (illustrated in FIG. 8). Movement of the carriage member 46 from the first position to the second position advancing a lubricant stick 100 out of the housing 22 and against the surface to be lubricated. The carriage member 46 is slidably mounted on a pair of rails 48, 48′, thereby enabling the carriage member 46 to be longitudinally moved from said first position to said second position, and back again.

The carriage member 46 comprises pivot joint 49 and a pawl 50 pivotally connected to said carriage member 46 at said pivot joint 49. The pawl 50 can be rotated from a forward stick engaging position (FIG. 8) to a rearward free position (FIG. 7).

Mounted adjacent the carriage member 46 is a rear limit switch 52 and a forward limit switch 54. Depression of the rear limit switch 52 causing the linear actuator 42 to extend and move the carriage member 46 from the first position to the second position. Depression of the forward limit switch 54 causing the linear actuator 42 to retract and move the carriage member 46 to move the carriage member 46 from the second position to the first position. In the exemplary lubricant dispenser 120 shown in FIG. 3, the back surface 66 of the carriage member 46 is able to contact the rear limit switch 52 (shown in FIG. 3) and carriage front surface 65 or the pawl front surface 67 is able to contact the forward limit switch 54.

The pawl 50 having a tooth 51 for engaging the lubricant stick exterior surface when the pawl 50 is in the forward stick engaging position. The tooth 51 comprising a surface (e.g., edge, tang, flange, appendage, extension, gripping portion) able to bite into or otherwise engage the lubricant stick 100 exterior surface 110.

As particularly illustrated in FIG. 9, when moving from the first position to the second position, the pawl 50 rotates to the forward stick engaging position. This causes the tooth 51 to engage the lubricant stick exterior surface 110. Extension of the linear actuator 42 advancing the lubricant stick 100 out of the lubricant dispenser 120 and into contact with the surface to be lubricated. As particularly illustrated in FIG. 10, when moving from the second position to the first position, the pawl 50 rotates to the rearward free position causing the tooth 51 to disengage the lubricant stick exterior surface as the linear actuator 42 retracts.

As particularly illustrated in FIG. 8, the exemplary lubricant dispenser 120 optionally having a kickback preventer 70 for preventing kickback of the lubricant stick 100. The kickback preventer 70 having a kickback preventer edge 73 that bites into the exterior surface 110 of the lubricant stick 100 if the lubricant stick 100 attempts to move back into the lubricant dispenser. The kickback preventer 70 preferably being spring biased, for instance through use of a spring portion 72 and a pivot 74. The exemplary lubricant dispenser 120 having at least one outfeed guide. Illustrated are three outfeed guides 75, 76, 77. The outfeed guides 75, 76, 77 aligning the lubricant stick and work with the kickback preventer 70 to prevent kickback.

A third exemplary lubricant dispenser is a top-of-rail solid stick applicator which uses a solid stick lubricant and a mechanical applicator attached to the locomotive or truck to provide continuous lubrication to the desired surface. The top-of-rail solid stick applicator is preferably mounted on the front truck of the first car behind the last locomotive. It is preferred that at least one top-of-rail solid stick applicator be mounted on each sides of the truck to ensure application of lubricant to both sides of the track.

A fourth exemplary lubricant dispenser comprises of the following components: (1) a housing having a chamber, and a magazine capable of storing multiple lubrication sticks; (2) an air pressure regulator; (3) an air driven cylinder; (4) multiple pneumatic switches to determine cylinder location; and (5) mounting brackets to attach the applicator to the truck frame.

A fifth exemplary lubricant dispenser uses the pneumatic main reservoir line at the rear of the locomotive as the supply line for powering the air driven cylinder. The incoming airline from the pneumatic main reservoir line connecting with the adjustable air pressure regulator, the regulator enabling the air pressure supplied to the pneumatic cylinder to be varied. The system operates by applying air pressure to the pneumatic cylinder. The cylinder able to move within the chamber. When the cylinder advances forward in the chamber, a solid lubricant stick within the chamber is forced into the contact with the car wheel, preferably at the taping line. The cylinder will continue to apply a continuous forward force, advancing the solid stick lubricant, until a “stop” position is released. The forward stop position relates to a forward most limit switch. Once engaged, the limit switch will reverse the direction of the cylinder forcing it to travel towards the rear of the feeding mechanism until reaching the rear stop position where, preferably, a rear limit switch works to change the direction of the cylinder. Along the way, a new solid lubricant stick is fed from the magazine into the lubricant chamber. This action effectively resets the cylinder and enables the feeding mechanism to continue to apply force on the new solid lubricant stick until such time all lubricant sticks have been utilized. If the applicator uses all lubricant contained in the magazine, the over center switch would rotate down and would shut off all air pressure to the cylinder to ensure it does not cycle continuously when empty. Once the magazine has been refilled, the operator simple resets the switch and the system operates in a normal fashion.

A sixth exemplary lubricant dispenser is a top-of-rail solid stick applicator mounted onto the truck frame or locomotive in a manner that would enable the solid stick to be placed in direct contact with either a wheel or the track. This exemplary lubricant dispenser utilizes compressed air. The main reservoir of the locomotive produces a supply of 150 psi. The cylinder used in the applicator will operate between 0 and 60 psi depending upon the application rate desired.

A seventh exemplary lubricant dispenser includes an electronically controlled pressure regulator that would be integrated with a global positioning system (GPS) unit. Based on the GPS data, the control system would be able to detect an upcoming curve and could increase the air pressure to the cylinder thereby increasing the lubrication application rate.

An eighth exemplary lubricant dispenser utilizes an electro-mechanical actuator powered by the locomotive's 72V DC power supply

A ninth exemplary lubricant dispenser comprises a cart or a “drag axel” which could be placed on or behind the locomotive to serve as applicator cart that could easily be moved between trains. Lubricant could be applied to the cart's wheels and then transferred to the rail, or the lubricant could be applied directly onto rail.

Any suitable structure and/or material can be used for an exemplary lubricant applicator, and a skilled artisan will be able to select an appropriate structure and material for the particular exemplary lubricant applicator based on various considerations, including the intended use of the lubricant applicator, the intended arena within which the lubricant applicator will be used, and the equipment and/or accessories with which the lubricant applicator is intended to be used, among other considerations.

It is noted that all structure and features of the various described and illustrated exemplary lubricant applicators can be combined in any suitable configuration for inclusion in a lubricant applicator according to a particular exemplary lubricant applicator. For example, a lubricant applicator according a particular embodiment can include neither, one, or both of housing and the magazine described above. Furthermore, a lubricant applicator according to a particular exemplary lubricant applicator can include neither, one, or all of the magazine empty controller, control means, magazine indicator, kickback preventer, and the outfeed guides described above.

The foregoing detailed description provides exemplary embodiments of the invention and includes the best mode for practicing the invention. The description and illustration of these embodiments is intended only to provide examples of the invention, and not to limit the scope of the invention, or its protection, in any manner.

What is claimed is:

1. A lubricant dispenser for dispensing lubricant sticks having an exterior surface, said lubricant dispenser comprising:
a housing for mounting to a frame of an object having a surface to be lubricated, said housing holding at least one lubricant stick, said housing comprising a longitudinally slidable carriage member; and
a linear actuator for reciprocating said carriage member along a longitudinal axis distally from a first position to a second position and advancing said at least one lubricant stick out of said housing and against said surface, and proximally from said second position to said first position.

2. The lubricant dispenser of claim 1, further comprising a magazine for holding a plurality of lubricant sticks, wherein said linear actuator sequentially advances said lubricant sticks out of said housing.

3. The lubricant dispenser of claim 1, wherein said carriage member is slidably mounted on at least one rail.

4. The lubricant dispenser of claim 1, wherein said carriage member comprises pivot joint and a pawl pivotally connected to said carriage member at said pivot joint, said pawl able to be rotated from a forward stick engaging position to a rearward free position.

5. The lubricant dispenser of claim 4, wherein said linear actuator attaches to said carriage member at said pawl.

6. The lubricant dispenser of claim 5, wherein said pawl has a tooth for engaging said lubricant stick exterior surface when said pawl is in said forward stick engaging position.

7. The lubricant dispenser of claim 6, wherein when moving from said first position to said second position, said pawl rotates to said forward stick engaging position causing said tooth to engage said lubricant stick exterior surface, and advancing said lubricant stick out of said lubricant dispenser and into contact with the surface to be lubricated.

8. The lubricant dispenser of claim 7, wherein when moving from said second position to said first position, said pawl rotates to said rearward free position causing said tooth to disengage said lubricant stick exterior surface.

9. The lubricant dispenser of claim 1, wherein said linear actuator is a pneumatic cylinder attached to an air supply.

10. The lubricant dispenser of claim 1, further comprising a pressure adjustment means for adjusting a force asserted by the linear actuator through the carriage member to the lubricant stick when moving said carriage member from said first position to a second position.

11. The lubricant dispenser of claim 10, wherein said linear actuator is a pneumatic cylinder attached to an air supply, and said pressure adjustment means comprises a pressure regulator.

12. The lubricant dispenser of claim 1, further comprising a control means for controlling the lubricant dispenser, wherein said control means comprises a digital controller, power source and a sensor means.

13. The lubricant dispenser of claim 2, further comprising a magazine empty controller for determining when said magazine is empty and for stopping further reciprocation of said linear actuator.

14. The lubricant dispenser of claim 1, wherein said carriage member comprises pivot joint and a pawl pivotally connected to said carriage member at said pivot joint, said pawl able to be rotated from a forward stick engaging position to a rearward free position, said pawl comprising a tooth for engaging said lubricant stick exterior surface when said pawl is in said forward stick engaging position; and said linear actuator attaches to said carriage member at said pawl; wherein when moving from said first position to said second position, said pawl rotates to said forward stick engaging position causing said tooth to engage said lubricant stick exterior surface, and advancing said lubricant stick out of said lubricant dispenser and into contact with the surface to be lubricated; and wherein when moving from said second position to said first position, said pawl rotates to said rearward free position causing said tooth to disengage said lubricant stick exterior surface.

15. A lubricant dispenser for dispensing lubricant sticks having an exterior surface, said lubricant dispenser comprising:
a housing for mounting to a frame of an object having a surface to be lubricated, said housing comprising a magazine holding a plurality of lubricant sticks, said housing comprising a longitudinally slidable carriage member, said carriage member comprising a pivot joint and a pawl pivotally connected to said carriage member at said pivot joint, said pawl able to be rotated from a forward stick engaging position to a rearward free position, said pawl comprising a tooth for engaging said lubricant stick exterior surface when said pawl is in said forward stick engaging position; and
a linear actuator attaching to said carriage at said pawl, said linear actuator for reciprocating said carriage member along a longitudinal axis from a first position to a second position, and when reciprocating said carriage member from said first position to said second position said carriage member sequentially advances said lubricant sticks out of said housing and against said surface.

16. The lubricant dispenser of claim 15, wherein when moving from said first position to said second position, said pawl rotates to said forward stick engaging position causing said tooth to engage said lubricant stick exterior surface, and advancing said lubricant stick out of said lubricant dispenser and into contact with the surface to be lubricated.

17. The lubricant dispenser of claim 15, wherein when moving from said second position to said first position, said pawl rotates to said rearward free position causing said tooth to disengage said lubricant stick exterior surface.

18. A lubricant dispenser for dispensing lubricant sticks having an exterior surface, said lubricant dispenser comprising:
a housing for mounting to a frame of an object having a surface to be lubricated, said housing comprising a magazine holding a plurality of lubricant sticks, said housing comprising a longitudinally slidable carriage member, said carriage member comprising a pivot joint and a pawl pivotally connected to said carriage member at said pivot joint, said pawl able to be rotated from a forward stick engaging position to a rearward free position, said pawl comprising a tooth for engaging said lubricant stick exterior surface when said pawl is in said forward stick engaging position; and
a linear actuator attaching to said carriage at said pawl, said linear actuator for reciprocating said carriage member along a longitudinal axis from a first position to a second position, and when reciprocating said carriage member from said first position to said second position said carriage member sequentially advances said lubricant sticks out of said housing and against said surface;
wherein when moving from said first position to said second position, said pawl rotates to said forward stick engaging position causing said tooth to engage said lubricant stick exterior surface, and advancing said lubricant stick out of said lubricant dispenser and into contact with the surface to be lubricated;
wherein when moving from said second position to said first position, said pawl rotates to said rearward free position causing said tooth to disengage said lubricant stick exterior surface.

19. The lubricant dispenser of claim 18, wherein said linear actuator is a pneumatic cylinder attached to an air supply, said lubricant dispenser further comprising a pressure regulator for adjusting a force asserted by the linear actuator through the carriage member to the lubricant stick when moving said carriage member from said first position to a second position.

20. The lubricant dispenser of claim 18, further comprising a magazine empty controller for determining when said magazine is empty and for stopping further reciprocation of said linear actuator.
